(19) United States
(12) Patent Application Publication
(10) Pub. No.: US 2026/0194725 A1
(43) Pub. Date: Jul. 9, 2026

(54) FIBER OPTIC CABLE HAVING EXTRUDED POLYMER MATRIX WITH CONTINUOUS REINFORCING FIBRILS AND ASSOCIATED METHOD

(71) Applicant: Eagle Technology, LLC, Melbourne, FL (US)

(72) Inventors: Felix Antonio TAN, Palm Bay, FL (US); Taylor MEEHAN, Melbourne, FL (US); Joao Pedro PEREIRA, Palm Bay, FL (US)

(21) Appl. No.: 19/012,999

(22) Filed: Jan. 8, 2025

(51) Int. Cl. G02B 6/44; G01V 8/16

(52) U.S. Cl. CPC G02B 6/4432; G01V 8/16

(57) ABSTRACT

A fiber optic cable may include an optical fiber having a core and a cladding surrounding the core. A jacket surrounds the optical fiber and includes an extruded polymer matrix, and a plurality of extruded, longitudinally-extending, continuous, reinforcing fibrils contained within the polymer matrix and coextruded therewith.

### FIELD OF THE INVENTION

The present invention relates to the field of fiber optic cable, and, more particularly, to fiber optic cable having protective jackets and related methods.

### BACKGROUND OF THE INVENTION

Fiber optic cable that is paid out or unwound from an initial stored or wound location should have sufficient tensile strength and flexibility to prevent damage to the optical fiber when subject to external forces that may compromise the optical link, for example, when operating a remotely operated underwater vehicle (ROV) where the fiber optic cable may be extended for longer distances. To ensure that the optical fiber formed from the core and surrounding cladding is not damaged, additional components and strengthening materials may be incorporated into the optical fiber that isolate the optical fiber from external forces. These additional components and materials often increase the diameter of the fiber optic cable and may decrease the maximum length available for use in a defined space, thus limiting the possible deployment length of the fiber optic cable. In special applications, e.g., operating a remotely operated underwater vehicle (ROV), this may be undesirable because an ROV may use thousands of yards or even multiple miles of deployed cable length.

Traditional manufacturing processes for fiber optic cable may include simultaneous “co-extrusion” of the multiple buffer layers surrounding the optical fiber. These techniques, however, have been found limiting in the formed cross-sectional architecture of the fiber optic cable that can be produced with two or more buffer polymers from a molten extruded state. Some current fiber optic cables incorporate strength members, such as high tensile strength polymer fibers that are incorporated linearly along the length of the optical fiber, and mixtures of polymer resins as a jacket to protect the optical fiber from external forces. The strength members may be formed from one or more high tensile strength polymer materials, fiberglass, steel, or similar metallic reinforcing members, or aramid fibers, such as Kevlar and Vectran. Some fiber optic cables have multiple layers of jacketing, metal tubing, and fiber strength members to protect the optical fiber, but these techniques consequently increase the size and weight of the fiber optic cable.

There have been some manufacturing techniques that attempt to address these issues and strengthen the fiber optic cable, without overly increasing its weight, diameter and cable size. These techniques include adding chopped fibers into a polymer jacketing.

Other manufacturing techniques include incorporating metal tubing with a gel material for the optical fiber to be suspended in. Some fiber optic cable includes an armoring layer with steel braiding. Other fiber optic cable manufacturing techniques extrude a “precursor” of polymeric strength member yarns laid directly into the cable. These methods, however, are limited because of their complexity, geometric configuration, and modularity for the extruded fiber optic cable architecture.

### SUMMARY OF THE INVENTION

A fiber optic cable may comprise an optical fiber having a core and a cladding surrounding the core. A jacket may surround the optical fiber and may comprise an extruded polymer matrix, and a plurality of extruded, longitudinally-extending, continuous, reinforcing fibrils contained within the polymer matrix and coextruded therewith.

The plurality of extruded, longitudinally-extending, continuous, reinforcing fibrils may be arranged in spaced relation within the matrix. The plurality of extruded, longitudinally-extending, continuous, reinforcing fibrils may be arranged along radii within the matrix, and in another example, may be arranged along concentric rings within the matrix.

At least one buffer layer may surround the cladding. The at least one buffer layer may comprise a primary buffer layer on the cladding and a secondary buffer layer on the primary buffer layer with the primary buffer layer being softer than the secondary buffer layer. A tertiary buffer layer may surround the secondary buffer layer. A layer of polymer fibers may be between the at least one buffer layer and the jacket. The extruded polymeric matrix may comprise at least one of LCP, TPE, LDPE, PP, and PVDF. The extruded reinforcing fibrils may comprise at least one of LCP, LDPE, PP, and PVDF.

Another aspect is directed to a method for making a fiber optic cable that may comprise forming a jacket to surround an optical fiber comprising a core and a cladding surrounding the core. The forming may comprise simultaneously extruding a polymer matrix and a plurality of longitudinally-extending, continuous, reinforcing fibrils to be contained within the polymer matrix.

### BRIEF DESCRIPTION OF THE DRAWINGS

Other objects, features and advantages of the present invention will become apparent from the detailed description of the invention which follows, when considered in light of the accompanying drawings in which:

FIG. 1 is an environmental view of an offshore drilling platform and a remote operated underwater vehicle (ROV), which may incorporate the fiber optic cable in accordance with a non-limiting example, such as for communications and control of sensors within the drilling apparatus and guidance of the ROV.

FIG. 2 is a sectional view of the fiber optic cable of FIG. 1 showing the jacket having reinforcing fibrils arranged in spaced relation within the extruded polymer matrix and primary, secondary, and tertiary buffer layers.

FIG. 3 is a sectional view of the fiber optic cable like that shown in FIG. 2, but without a tertiary buffer and layer of polymer fibers.

FIG. 4 is another sectional view of the fiber optic cable like that shown in FIG. 3, where the reinforcing fibrils are arranged in outer concentric rings within the extruded polymer matrix.

FIG. 5 is yet another sectional view of the fiber optic cable like that shown in FIG. 4, where the reinforcing fibrils are arranged along radii within the extruded polymer matrix.

FIG. 6 is a high-level flowchart of a method for making the fiber optic cable.

### DETAILED DESCRIPTION

The present description is made with reference to the accompanying drawings, in which exemplary embodiments are shown. However, many different embodiments may be used, and thus, the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

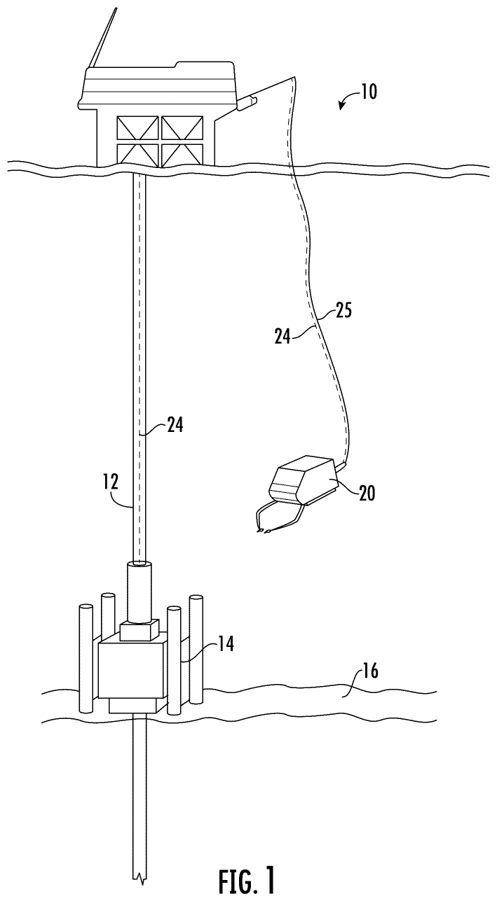

Referring now to FIG. 1, there is illustrated an environmental view of an offshore drilling platform 10 that operates a drilling apparatus 12, and showing a blowout preventer 14 on the sea floor 16. The drilling apparatus 12 may incorporate the fiber optic cable 24 shown by the dashed line, such as for communication with sensors contained in the drilling apparatus. A remotely operated underwater vehicle (ROV) 20 in this example may include the fiber optic cable 24 for communications and control of the ROV 20, which is linked to a strong support cable or guidewire 25 to support the ROV.

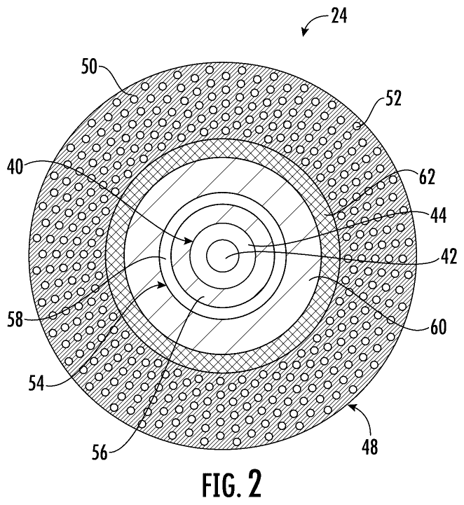

Referring now to the sectional view of FIG. 2, the fiber optic cable 24 has a structured cross-section and configuration that removes the need of adding extra material as linearly laid fiberglass, steel or aramid strength members. The fiber optic cable 24 includes an optical fiber 40 having a core 42 and cladding 44 surrounding the core. A jacket 48 surrounds the optical fiber 40 and is formed as an extruded polymer matrix 50 and a plurality of extruded, longitudinally-extending, continuous, reinforcing fibrils 52 contained within the polymer matrix and coextruded therewith. In an example, the reinforcing fibrils 52 are arranged in spaced relation within the extruded polymer matrix 50. In this example, at least one buffer layer 54 surrounds the cladding 44, and as illustrated includes a primary buffer layer 56 on the cladding and a secondary buffer layer 58 on the primary buffer layer, with the primary buffer layer being softer than the secondary buffer layer. A tertiary buffer layer 60 may surround the secondary buffer layer 58 as illustrated, and a layer of polymer fibers 62 may be between the at least one buffer layer 54 and the jacket 48 that surrounds the optical fiber 40 and form strengthening members.

The extruded polymeric matrix 50 may be formed from different resins, such as at least one of a thermoplastic elastomer (TPE), low-density polyethylene (LDPE), polypropylene (PP), polyvinylidene fluoride (PVDF), or a liquid crystal polymer (LCP). The extruded reinforcing fibrils 52 may be formed from an additional, but different resin than that of the extruded polymeric matrix 50, such as at least one of a liquid crystal polymer (LCP), low-density polyethylene (LDPE), polypropylene (PP), and polyvinylidene fluoride (PVDF) in a structured cross-section to create the composite jacket 48. This structured cross-section for the jacket 48 of the fiber optic cable 24 having the plurality of extruded, longitudinally-extending, continuous, reinforcing fibrils 52 contained within and coextruded with the polymer matrix forms a structure that some skilled in the art refer to as an “Islands-in-the-Sea” cable.

In a non-limiting example, the extruded polymer matrix 50 may be a liquid crystal polymer, such as the base material used in Vectran. However, one or more additional resins, such as TPE, PP, PVDF, or another liquid crystal polymer, may be used for the coextruded reinforcing fibrils 52 to create the composite jacket 48 and protect the optical fiber 40.

The jacket 48 cross-section may include over 300 extruded, longitudinally-extending, continuous, reinforcing fibrils 52 distributed in the extruded polymer matrix 50 in concentric layers as shown in FIG. 2, and in spaced relation to each other. The reinforcing fibrils 52 may range in diameter from between about 15 to about 30 micrometers, and the number of fibril layers and layer spacing may vary depending on strength and flexibility requirements for the fiber optic cable 24. The use of the extruded, longitudinally-extending, continuous, reinforcing fibrils 52 contained within the extruded polymer matrix 50 allows for a continuous composite jacket 48 having uniform tensile properties. The manufacture of the fiber optic cable 24 is simplified by removing the requirement of adding extra strengthening material, such as the illustrated layer of polymer fibers 62 between the at least one buffer layer 54 and the jacket 48, and thus, reduce the overall thickness of that layer of polymer fibers operating as a strengthening layer.

The jacket 48 imparts a uniform tensile strength to the fiber optic cable 24 and permits flexibility when the fiber optic cable is in use, such as shown in FIG. 1 where it is part of the drilling apparatus 12 as explained above to receive signals from sensors in the drilling apparatus or allow communications and control to and from the ROV 20. The fiber optic cable 24 is formed as silica-based optical fiber 40 that includes its core 42 and surrounding cladding 44, which in an example is a COTS (commercial-off-the-shelf) single-mode optical fiber such as manufactured by OFS, Inc. of Norcross, Georgia.

In an example, the at least one buffer layer 54 that includes the primary buffer layer 56 on the cladding 44 and the secondary buffer layer 58 on the primary buffer layer are formed as a dual, acrylate buffer layer with the primary buffer layer being a softer primary acrylic coating than the harder secondary buffer coating. The tertiary buffer layer 60 may be formed as another plastic layer, including an example hard acrylic layer or thermoplastic polymer, increasing the optical fiber outer diameter to about 300 to about 600 micrometers. The layer of polymer fibers 62 between the at least one buffer layer 54 and the jacket 48 form a layer of strength members and may be formed from high tenacity polymer fibers, for example, liquid crystal polymer fibers that are linearly laid along the length fiber optic cable 24. This layer of polymer fibers 62 forming the strength members can range in their size and quantity, depending on the desired tensile properties to be imparted to the final fiber optic cable 24.

The jacket 48 that surrounds the optical fiber 40 may be directly extruded over the internal components, such as the optical fiber 40, the first, second and tertiary buffer layers 56,58,60, and layer of polymer fibers 62 as shown in the sectional view of FIG. 2. The different resins used for the extruded reinforcing fibrils 52 may be selected to modify the mechanical and physical properties of the jacket 48. In an example, the reinforcing fibrils 52 may be extruded with up to 10 concentric rows and 36 individual cores, ranging in diameter from about 10 to about 35 micrometers. The multiple, concentric rows and reinforcing fibril 52 count may be adjusted to controllably modify the compressibility and mechanical properties of the fiber optic cable 24.

The incorporation of the jacket 48 surrounding the optical fiber 40 having the extruded polymer matrix 50 and plurality of extruded, longitudinally-extending, continuous, reinforcing fibrils 52 contained therein and coextruded therewith maintains a smaller form factor for the fiber optic cable 24. This structure also provides enhanced physical properties to survive the external forces from payout, deployment and use, such as the example of FIG. 1, where the fiber optic cable 24 operates as a communications and control cable to the ROV 20 in underwater exploration. The fiber optic cable 24 can be extended in operation for several miles, and still maintain the necessary strength and flexibility for use in the demanding environments, such as underwater with the ROV 20.

The manufacturing process may impart desired material properties into a single, long length fiber optic cable 24. The physical properties and behaviors of the fiber optic cable 24 can be tuned by judicious selection of the different polymer materials and form factors for the reinforcing fibrils 52 that are coextruded within the polymer matrix 50, and by selecting the number, location, and size of the reinforcing fibrils. Other physical properties can be imparted by modifying the at least one buffer layer 54 and the layer of polymer fibers 62 between the at least one buffer layer and the jacket 48 as in the example of FIG. 2.

The jacket 40 may be produced by different manufacturing processes. An example process employs an electro-spinning head or other spin pack hardware components, such as developed by Hills, Inc. of Melbourne, Florida, for co-extrusion and disclosed in U.S. Pat. No. 6,861,142. The judicious selection of the different buffer layers 56,58,60 and layer of polymer fibers 62, and the number and configuration of the reinforcing fibrils 52 may vary.

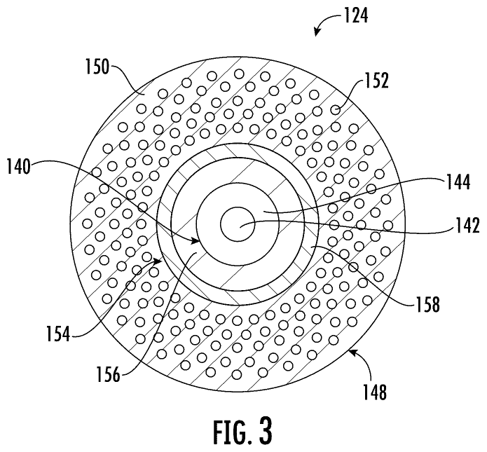

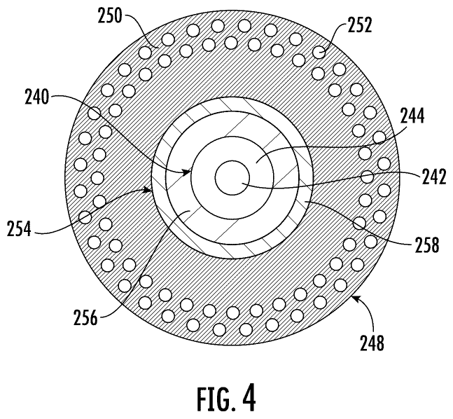

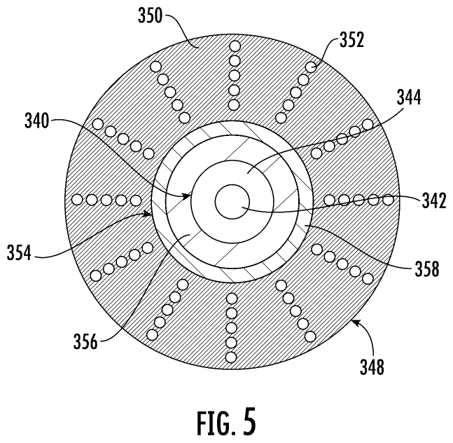

Referring now to the examples of FIG. 3-5, an example fiber optic cable 24 like that shown in FIG. 2 includes the jacket 48, but no tertiary buffer layer 60 and layer of polymer fibers 62 as shown in FIG. 2. Like numerals similar to those described relative to FIG. 2 are used for reference with FIGS. 3-5, except reference numerals in the 100 series are used for FIG. 3, the 200 series are used for FIG. 4, and the 300 series are used for FIG. 5.

The fiber optic cable 124 shown in FIG. 3 still maintains the reinforcing fibrils 152 in spaced relation within the extruded polymer matrix 150. The sectional views of the fiber optic cable 224,324 shown in respective FIGS. 4 and 5 illustrate the fiber optic cable without a tertiary buffer layer 60 and without the layer of polymer fibers 62 of FIG. 2. The reinforcing fibrils 252 are arranged in outer concentric rings within the extruded polymer matrix 250 (FIG. 4). The reinforcing fibrils 352 in FIG. 4 are arranged along radii within the extruded polymer matrix 350 (FIG. 5).

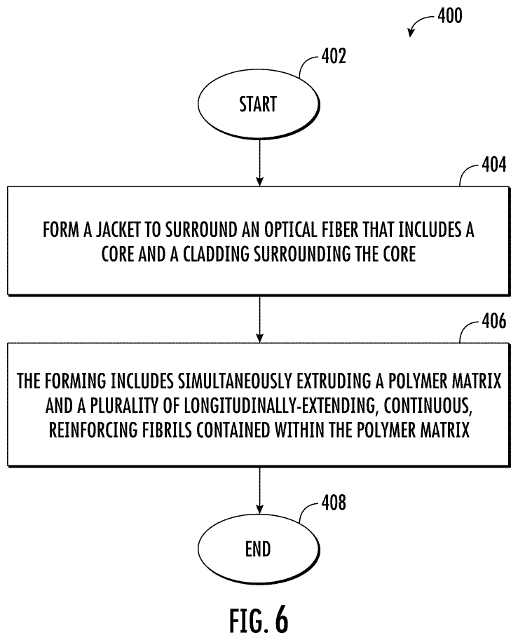

Referring now to FIG. 6, an example high-level flowchart of the method for making the fiber optic cable 24,124,224,324 is shown generally at 400. The process starts (Block 402) and a jacket 48,148,248,348 is formed to surround the optical fiber 40,140,240,340 and includes a core 42,142,242,342 and a cladding 44,144,244,344 surrounding the core (Block 404). This forming step includes simultaneously extruding a polymer matrix 50,150,250,350 and a plurality of longitudinally-extending, continuous, reinforcing fibrils 52,152,252,352 contained within the extruded polymer matrix (Block 406). The process ends (Block 408).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A fiber optic cable comprising:
an optical fiber comprising a core and a cladding surrounding the core; and
a jacket surrounding the optical fiber and comprising
an extruded polymer matrix, and
a plurality of extruded, longitudinally-extending, continuous, reinforcing fibrils contained within the polymer matrix and coextruded therewith.

2. The fiber optic cable of claim 1, wherein the plurality of extruded, longitudinally-extending, continuous, reinforcing fibrils are arranged in spaced relation within the matrix.

3. The fiber optic cable of claim 2, wherein the plurality of extruded, longitudinally-extending, continuous, reinforcing fibrils are arranged along radii within the matrix.

4. The fiber optic cable of claim 2, wherein the plurality of extruded, longitudinally-extending, continuous, reinforcing fibrils are arranged along concentric rings within the matrix.

5. The fiber optic cable of claim 1, comprising at least one buffer layer surrounding the cladding.

6. The fiber optic cable of claim 5, wherein the at least one buffer layer comprises a primary buffer layer on the cladding and a secondary buffer layer on the primary buffer layer with the primary buffer layer being softer than the secondary buffer layer.

7. The fiber optic cable of claim 6, comprising a tertiary buffer layer surrounding the secondary buffer layer.

8. The fiber optic cable of claim 5, comprising a layer of polymer fibers between the at least one buffer layer and the jacket.

9. The fiber optic cable of claim 1, wherein the extruded polymeric matrix comprises at least one of LCP, TPE, LDPE, PP, and PVDF.

10. The fiber optic cable of claim 1, wherein the extruded reinforcing fibrils comprise at least one of LCP, LDPE, PP, and PVDF.

11. A fiber optic cable comprising:
an optical fiber comprising a core and a cladding surrounding the core; and
a jacket surrounding the optical fiber and comprising
an extruded polymer matrix, and
a plurality of extruded, longitudinally-extending, continuous, reinforcing fibrils contained within the polymer matrix and coextruded therewith, the plurality of extruded, longitudinally-extending, continuous, reinforcing fibrils being arranged in spaced relation within the matrix along radii and concentric rings within the matrix.

12. The fiber optic cable of claim 11, comprising at least one buffer layer surrounding the cladding.

13. The fiber optic cable of claim 12, wherein the at least one buffer layer comprises a primary buffer layer on the cladding and a secondary buffer layer on the primary buffer layer with the primary buffer layer being softer than the secondary buffer layer.

14. The fiber optic cable of claim 12, comprising a tertiary buffer layer surrounding the secondary buffer layer.

15. The fiber optic cable of claim 11, comprising a layer of polymer fibers between the at least one buffer layer and the jacket.

16. The fiber optic cable of claim 11, wherein the extruded polymeric matrix comprises at least one of LCP, TPE, LDPE, PP, and PVDF.

17. The fiber optic cable of claim 11, wherein the extruded reinforcing fibrils comprise at least one of LCP, LDPE, PP, and PVDF.

18. A method for making a fiber optic cable comprising:
forming a jacket to surround an optical fiber comprising a core and a cladding surrounding the core; and
the forming comprising simultaneously extruding a polymer matrix and a plurality of longitudinally-extending, continuous, reinforcing fibrils to be contained within the polymer matrix.

19. The method of claim 18, wherein the plurality of extruded, longitudinally-extending, continuous, reinforcing fibrils are arranged in spaced relation within the matrix.

20. The method of claim 19, wherein the plurality of extruded, longitudinally-extending, continuous, reinforcing fibrils are arranged along radii within the matrix.

21. The method of claim 19, wherein the plurality of extruded, longitudinally-extending, continuous, reinforcing fibrils are arranged along concentric rings within the matrix.

22. The method of claim 18, comprising forming at least one buffer layer surrounding the cladding.

23. The method of claim 18, wherein the extruded polymeric matrix comprises at least one of LCP, TPE, LDPE, PP, and PVDF.

24. The method of claim 18, wherein the extruded reinforcing fibrils comprise at least one of LCP, LDPE, PP, and PVDF.
